(19) United States
(12) Patent Application Publication
(10) Pub. No.: US 2020/0148072 A1
(43) Pub. Date: May 14, 2020

(54) ENERGY CREDIT ACCOUNTING AND MANAGEMENT USING BLOCKCHAIN

(71) Applicant: Helpanswers Charitable Foundation, Inc., Naples, FL (US)

(72) Inventors: Michael J. Ashley, Chicago, IL (US); Mark S. Johnson, Naples, FL (US)

(21) Appl. No.: 16/676,838

(22) Filed: Nov. 7, 2019

Related U.S. Application Data
(60) Provisional application No. 62/757,418, filed on Nov. 8, 2018.

(51) Int. Cl. B60L 53/66; H04L 9/06; G06Q 20/36; G06Q 20/14; G06Q 50/06; G01D 4/00

(52) U.S. Cl. CPC B60L 53/665; H04L 9/0637; G01D 4/002; G06Q 20/145; G06Q 50/06; G06Q 20/3678

(57) ABSTRACT

The disclosed system and methods advantageously track credits from generation through ownership trades to retirement; raw data will be submitted to one blockchain or a conventional database, while credit transactions will be tracked on a separate blockchain. This system leaves a simple audit trail, significantly reducing the time and cost associated with reconciliation and auditing and enables producers to monetize their credits quickly after generation. Importantly, while microtransactions are currently prohibitively expensive, the use of blockchain technology enables smaller producers to participate in credit programs, and incentives to be designed at the consumer level.

### PRIORITY CLAIM

This application is a non-provisional of, claims priority to and the benefit of, U.S. Provisional Patent Application No. 62/757,418, filed on Nov. 8, 2018, the contents of which is incorporated by reference herein in its entirety.

### FIELD OF THE INVENTION

Various embodiments of the present invention provide a utility-grade end-to-end accounting, management, and exchange system for energy-related credits. In some embodiments, the disclosed systems and methods rely on a blockchain-based ledger to store and manage data related to generation, ownership trades, and retirement of credits.

### BACKGROUND

Certain energy credits exist for various purposes. In particular, the systems and methods disclosed herein address, handle, and manage at least the following four types of known energy-related credits:

(A) Renewable energy credits (sometimes referred to as “RECs”), which may each represent one megawatt-hour (MWh) of clean energy that the credit-holder has fed into a power grid;

(B) Energy efficiency (sometimes referred to as “EE”) credits, which may each represent the credit-holder having avoided one MWh of electricity usage due to energy efficiency upgrades;

(C) Net metering credits, which may each represent one kilowatt-hour (kWh) of energy sold by an electricity “prosumer” (producer and consumer) to the serving utility; and

(D) Carbon offset credits, which may each represent one metric ton of avoided CO₂-equivalent emissions due to low carbon intensity fuel or energy use compared to a baseline (e.g., Low Carbon Fuel Standard credits) or due to negative-CO₂ activities, such as improving agricultural practices to contain carbon in soil.

In certain scenarios, participants in energy credit programs can purchase and redeem credits to claim responsibility for clean energy generation and/or use. These programs incentivize investments in clean energy/energy efficient/carbon-negative assets, as credits are awarded owners of these assets. Because such awarded credits are transferrable assets, credit-holders can turn these credits into additional revenue streams by selling or otherwise disposing of owned credits.

Although existing systems and methods have partially incentivized (and facilitated the incentivization of) clean energy and environmental projects, credit systems known to the applicants herefor still suffer from serious drawbacks, such as inefficient accounting and management procedures. In such known systems, credit ownership and transfers are monitored manually, with credit generation and ownership transfers often recorded on simple, non-dynamic spreadsheets. Typically, credit transfers are only reconciled quarterly (when data sets are submitted) and credits are awarded months later. These activities are challenging to verify and reconcile, and require costly and time-consuming auditing, and in some cases, still suffer from “double-counting” issues, which can jeopardize the integrity and incentives of the system.

What is needed is a system and method that permits efficient transfer of, and accounting for the transfer of, energy credits in relatively real-time while avoiding “double-counting” and other integrity-risking issues.

### SUMMARY

Embodiments of the disclosed system and methods disclosed herein address the above problems and improve on known mechanisms for tracking and otherwise managing energy credits. Various embodiments of the system and methods disclosed herein provide a utility-grade end-to-end accounting, management, and exchange system for energy-related credits, with generation, ownership trades, and retirement. In embodiments of the system and methods disclosed herein, these functions are provided by recording data on a blockchain-based ledger or other type of distributed ledger technology secured by cryptographic signatures.

In particular, in one embodiment, the disclosed system and methods involve a novel end-to-end accounting and management system for energy-related credits (such as RECs, carbon offset credits, EE credits, and net metering credits) that, using blockchain technology or other appropriate conventional database technology, provides transparency, security, and simple reconciliation and auditability for reductions in the associated time and cost. In such an embodiment, some or all of the raw data is stored “off-chain” to reduce congestion in the blockchain.

In embodiments of the disclosed system, when a certified clean energy professional has verified a new clean energy/energy efficiency/carbon-negative asset, raw data can be submitted by the end-users via near-real time energy meter direct uploads. For example, raw data can be submitted by end-users from assets such as solar panels, battery storage systems, electric vehicle chargers, wind turbines, energy efficient machinery, etc. In some embodiments, the disclosed system and methods permit the manual submission of data via spreadsheets or browser user interfaces to an information repository of the disclosed system.

In some such embodiments, the data submitted by the clean energy professional is entered into a raw data blockchain instance or another kind of conventional database. Data from the raw data blockchain instance or conventional database may be queried and subsequently used to generate new credits based on established criteria for the specific type of credit. In particular, the data provided to the disclosed system may be parsed according to known techniques to determine and generate new credits reflective of the uploading activity.

In various embodiments, the disclosed system permits credits to be escrowed from the asset owner's digital wallet and sold on the open market. The disclosed system may provide a marketplace-type interface both to sellers and buyers of credits, to permit users to exchange credits once they have been generated as described above. In some embodiments, credit transactions and retirement events are executed and recorded on the credit exchange blockchain instance.

In some embodiments, the system and methods disclosed herein include a searchability feature in the blockchain ledger (or other conventional database). In such embodiments, the disclosed system and methods use the blockchain ledger (or other conventional database) to accumulate pertinent (searchable) data in one place. The system and methods may then tag the stored data, such that data/transactions (from the entire history) can be filtered by any meaningful criteria (i.e., entities involved, quantity transacted, date/time, energy generated, etc.) and credits can be tracked from generation to retirement, for fast and simple auditing.

### BRIEF DESCRIPTION OF THE FIGURES

FIG. 1 is a flowchart illustrating a sample architecture of the blockchain-based end-to-end energy-related credit accounting, management, exchange, and audit system according to the disclosed embodiments.

### DETAILED DESCRIPTION

To facilitate the widespread adoption of clean energy, the need exists to devise practical economic incentives to deploy clean energy assets while reducing barriers to access that clean energy. While energy-related credits (i.e., renewable energy credits, energy efficiency credits, net metering credits, and carbon offset credits) may push these goals forward, the associated accounting and management systems known to the applicants herefor still suffer from numerous flaws that drive costs up and slow the monetization of clean energy assets.

Blockchain technology has emerged as a promising solution that can provide a secure and transparent distributed ledger, with the capability of autonomously executing transactions upon fulfillment of pre-defined criteria (“smart contracts”). As a result, the disclosed system and methods advantageously track credits from generation through ownership trades to retirement; raw data will be submitted to one blockchain instances or other type of conventional database, while credit transactions will be executed and recorded on a separate, searchable blockchain. This system leaves a simple audit trail, significantly reducing the time and cost associated with reconciliation and auditing and enables producers to monetize their credits quickly after generation. Importantly, while microtransactions are currently prohibitively expensive, the use of blockchain technology enables smaller producers to participate in credit programs, and incentives to be designed at the consumer level.

Embodiments of the present disclosure provide a utility-grade end-to-end accounting, management, and exchange system for energy-related credits, with generation, ownership trades, and retirement recorded on blockchain-based ledgers (raw data, along with a cryptographic signature generated upon data submission, may be submitted to a conventional database and subsequently queried by a blockchain).

It should be appreciated that blockchain is generally understood as a digitized, distributed ledger, in which entries/transactions are secured by cryptographic signatures, such that the historical record of transactions cannot be tampered with and leaves a verifiable audit trail. Blockchain technology has emerged as a promising solution to alleviate the issues associated with conventional credit management systems.

In some embodiments of the system and methods disclosed herein, an end-to-end accounting, management, and exchange system is provided for handling energy-related credits, with generation, ownership trades, and retirement recorded on a blockchain-based ledger. In these embodiments, historical raw data (used to determine appropriate credit generation) and credit exchange data can be accessed on a tamper-proof ledger for improved transparency, security, and auditability. In certain embodiments, the invention is a holistic solution for energy-related credit accounting and management.

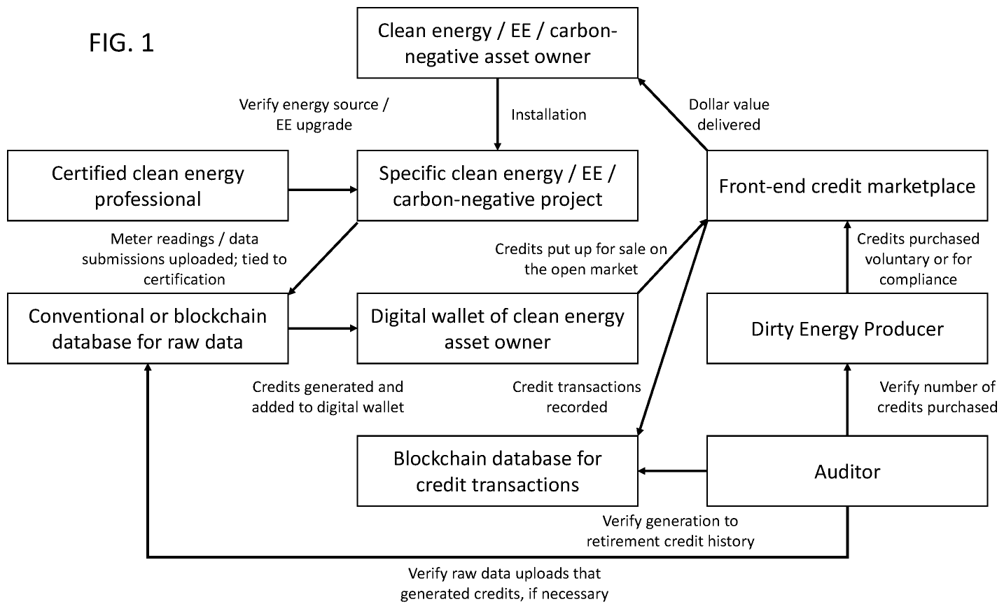

FIG. 1 is a flowchart showing an embodiment of the end-to-end solution of the blockchain-based system described herein. In particular, embodiment shown in the flowchart of FIG. 1 begins with the installation of new clean energy generation (e.g. solar array, wind farm, hydroelectric facility, etc.), energy efficiency (e.g., HVAC, LEDs, etc.), or low-carbon/carbon-negative (e.g., improving agricultural practices to contain carbon in soil, low-carbon fuel use relative to an established baseline carbon intensity, etc.) assets. These assets may be inspected by a certified clean energy professional (e.g., from the Association of Energy Engineers, AEE), whose asset verification will be tied to all future data submissions associated with those assets.

In the cases of energy generation or reduced energy use, near-real time energy data (i.e., 15- or 30-minute intervals) can be uploaded directly to a blockchain instance or a conventional database along with cryptographic signatures for a tamper-proof record of raw energy data.

In some embodiments, if near-real time energy meter data is not required for a certain application, “raw” data will instead refer to manual data submissions made by the end-user, either via spreadsheet or browser user interface.

Regardless of input method, data in some embodiments of the disclosed system and methods is parsed and cryptographically signed as a blockchain entry. Based on pre-defined criteria for credit generation (as described above), digital representations of credits are autonomously or manually generated and added to the digital wallet of the asset owner once specified conditions are met (i.e., 1 metric ton of CO₂-equivalent has been avoided, etc.).

Once generated and added to the asset owner's wallet, embodiments of the disclosed system permit credits to be put up for sale on the open market. Subsequently, dirty energy/fuel producers can use an interface to the described system to purchase credits to meet a regulatory mandate, or other entities can purchase credits voluntarily to make claims about their increased clean energy use or their reduced carbon footprint.

In various embodiments, credit transactions are recorded on a separate blockchain instance, where ownership trades and retirement activity is executed and recorded. Between the various databased/ledgers employed in the embodiments of the disclosed system and methods, auditors can verify the raw data used to generate credits, in addition to ownership trades and retirement, on cryptographically secure ledgers. This simplifies the audit process of credit purchasers as well as transaction reconciliation. Ultimately, the clean energy/energy efficiency/carbon-negative asset owner is rewarded with a revenue stream from credit sales, while the cost (in time and money) of operating the enabling system is reduced.

In one embodiment, the system and methods described herein provide a novel accounting and management system for energy-related credits (RECs, carbon offset credits, EE credits, and net metering credits) that, using blockchain technology, provides transparency, security, and simple reconciliation and auditability for reductions in the associated time and cost. Other embodiments include tracking, verifying, and recording various types of data, beyond energy data, for audit purposes (e.g., compliance, finances, IT/security controls, etc.).

In some embodiments, smart contracts, an important addition to blockchain technology, can provide an automated execution function based on logic within embodiments of the disclosed system. For example, if Person A pays Person B an agreed-upon amount, then a credit will be autonomously transferred from Person B's digital wallet to Person A's digital wallet (facilitated by escrowed funds and credits). All transactions are verified using cryptography. This permits the system to effectively provide a marketplace with fast transfer of energy credits.

In some embodiments, to generate energy-related credits, smart meter interval data is fed into a cloud database, with meter identification, clean energy verification, energy production data and time stamps autonomously determining when credits should be awarded. Tokenized credits, which are secure digital representations of credits, awarded, traded, and retired via blockchain can dramatically reduce the time and cost associated with tracking and redeeming credits. These credits will be autonomously generated once requisite conditions are met, and subsequently can be easily tracked from ownership trades to retirement on a fully transparent, distributed ledger. Similarly, if near-real time energy data is not available or not required for credit generation, data can be manually submitted by the end-user via spreadsheets or browser user interfaces. These data can be parsed and autonomously converted into blockchain entries.

In various embodiments, the system disclosed herein also provides verification of clean energy generation and related assets by certified clean energy professionals (e.g., AEE-certified Energy Auditor). This verification activity allows credits transacted on the blockchain platform to originate from prequalified clean energy assets, and certification is linked to all data submissions from a particular asset. This verification cuts associated audit time, resources, and costs.

In various embodiments, after credits have been generated, they are deposited into the asset owner's digital wallet. Credits for sale are put into escrow, after which a buyer can purchase them at market price. Payment processing triggers credit release from escrow, and credits are transferred to the buyer. Transaction details are then recorded on the credit exchange blockchain, and the buyer can redeem credits and claim responsibility for the clean energy production, EE-enabled usage reduction, or reduced carbon emissions. The use of blockchain technology eliminates the need to reconcile transaction data, as the secure, distributed ledger acts as a single source of historical truth. While amendments to previous transactions can be made in the event of an error in meter data upload or manual submission, once an entry is added to the blockchain (cryptographically signed by all parties involved), it cannot be altered.

It should be appreciated that regulators and auditors can use this immutable audit trail to easily verify the generation-to-retirement path of credits tracked in this way. The invention includes a searchability feature in the blockchain ledger; using such a ledger, all relevant data is accessible in one place, and all data is tagged, such that data/transactions (from the entire history) can be filtered by any meaningful criteria (i.e., entities involved, quantity transacted, date/time, energy generated, etc.) and credits can be tracked from generation to retirement, for fast and simple auditing.

It should be appreciated that various embodiments of the system and methods described herein simplify the complex, high volume credit trading environment, while making transactions feasible that were previously prohibitively expensive. Credit tracking from generation (from a certified clean energy or related asset) through ownership trades to retirement involves a modified usage of the Blockchain of Custody™ (a trademark of the instant applicant) process, with a purpose of automating clean energy verification from credit generation to retirement. This transaction process leaves a simple audit trail and enables investors in clean energy or related assets to monetize their credits quickly.

In one embodiment, the system and methods described herein are exemplified by applications to electric vehicle chargers powered by solar plus battery storage electricity. In some instances, electricity dispensed as fuel for electric vehicles qualifies for credits in Low Carbon Fuel Standard programs, wherein one credit represents one metric ton of CO₂-equivalent emissions avoided. In embodiments of the disclosed is system, raw data describing solar generation, battery storage of clean electricity, and consumption of that electricity by electric vehicle chargers may be collected and queried by the credit exchange blockchain, such that one Low Carbon Fuel Standard credit is autonomously created after the requisite amount of electricity has been dispensed to the electric vehicle chargers (this specific quantity will vary over time). It should be appreciated that the use of grid electricity versus solar electricity is differentiated in many credit programs; in Low Carbon Fuel Standard programs, the lower carbon intensity of solar electricity is accounted for in credit awarding, and therefore fewer kilowatt-hours need to be dispensed to generate a credit compared to grid electricity use. Thus, it is of high importance to track the origin of the electricity used in these applications.

It should be further appreciated that in some embodiments, the system disclosed herein provides the following beneficial features:

(1) Holistic and utility-grade end-to-end accounting, management, and exchange system for energy-related credits, with generation, ownership trades, and retirement recorded on blockchain-based ledgers;

(2) Historical raw data (used to determine appropriate credit generation) and credit exchange data can be accessed on a tamper-proof ledger for improved transparency, security, and auditability;

(3) Transparent data storage on blockchain-based ledgers for energy-related credits, all relevant historical data accessible with a searchability feature by any meaningful tag;

(4) Autonomous credit generation upon fulfillment of pre-determined criteria (with data submitted via direct smart meter interval uploads or manual spreadsheet or browser user interface submissions); and/or

(5) Asset certification tied to all data uploads related to that particular asset.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain known modes of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

The invention is claimed as follows:

1. An energy credit management system comprising:
at least one processor;
at least one input device; and
at least one memory device storing a plurality of instructions which, when executed by the at least one processor, cause the at least one processor to:
(a) permit a user to provide a plurality of inputs reflective of energy-related activity;
(b) determine whether said plurality of inputs indicate that an energy credit should be issued to the user;
(c) if the determination is that an energy credit should be issued to the user, altering the blockchain-based ledger of credits to indicate the provision of said energy credit to said user;
(d) if a transfer input indicates that said energy credit should be transferred, altering a blockchain-based ledger of credits to indicate that said user no longer has said credit, and that a different user has said credit; and
(e) storing an indication of said indication that said energy credit should be transferred in a blockchain-based ledger.

2. The system of claim 1, wherein the plurality of instructions cause the at least one processor to determine that said energy credit should be retired and to update said blockchain-based ledger to reflect said determination.

3. The system of claim 1, which includes at least one display device, and wherein the plurality of instructions cause the at least one processor to operate with the at least one display device to display permit the user to enter at least one search input and to cause the display of any credits that match said at least one input.

4. The system of claim 1, which includes at least one smart meter, and wherein the plurality of instructions cause the at least one processor to receive a plurality of meter inputs automatically from said at least one smart meter on a predetermined interval, and to determine whether credits should be issued based on said received plurality of meter inputs.

5. The system of claim 1, wherein at least one of the plurality of inputs is related to electric vehicle charging-related activity.

6. The system of claim 5, wherein the vehicle charging-related activity includes an amount of electricity that has been dispensed to a plurality of electric vehicle chargers.

7. The system of claim 5, wherein said energy credit is based, at least in part, on whether grid electricity, solar electricity, or a combination of grid electricity and solar electricity was used in the electric vehicle charging-related activity.

8. The system of claim 5, wherein said blockchain-based ledger stores information related to battery storage of clean energy and consumption of that electricity by electric vehicle chargers.

9. An energy credit management system comprising:
at least one processor;
at least one input device; and
at least one memory device storing a plurality of instructions which, when executed by the at least one processor, cause the at least one processor to:
(a) permit a user to provide a plurality of inputs reflective of energy-related activity, said plurality of inputs being stored in a conventional database;
(b) determine whether said plurality of inputs indicate that an energy credit should be issued to the user;
(c) if the determination is that an energy credit should be issued to the user, altering a blockchain instance storing an indication of credits to indicate the provision of said energy credit to said user;
(d) if a transfer input indicates that said energy credit should be transferred, altering the blockchain instance to indicate that said user no longer has said credit, and that a different user has said credit; and
(e) storing an indication of said indication that said energy credit should be transferred in the blockchain instance.

10. The system of claim 9, wherein the plurality of instructions cause the at least one processor to determine that said energy credit should be retired and to update said blockchain instance to reflect said determination.

11. The system of claim 9, which includes at least one display device, and wherein the plurality of instructions cause the at least one processor to operate with the at least one display device to display permit the user to enter at least one search input and to cause the display of any credits that match said at least one input.

12. The system of claim 9, which includes at least one smart meter, and wherein the plurality of instructions cause the at least one processor to receive a plurality of meter inputs automatically from said at least one smart meter on a predetermined interval, and to determine whether credits should be issued based on said received plurality of meter inputs.

13. The system of claim 9, wherein at least one of the plurality of inputs is related to electric vehicle charging-related activity.

14. The system of claim 13, wherein the vehicle charging-related activity includes an amount of electricity that has been dispensed to a plurality of electric vehicle chargers.

15. The system of claim 13, wherein said energy credit is based, at least in part, on whether grid electricity, solar electricity, or a combination of grid electricity and solar electricity was used in the electric vehicle charging-related activity.

16. The system of claim 13, wherein at least one of said conventional database and said blockchain instance stores information related to battery storage of clean energy and consumption of that electricity by electric vehicle chargers.
